(19) United States
(12) Patent Application Publication
(10) Pub. No.: US 2009/0280860 A1
(43) Pub. Date: Nov. 12, 2009

(54) MOBILE PHONE WITH DIRECTIONAL FORCE FEEDBACK AND METHOD

(75) Inventor: Mikael DAHLKE, Trangsund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/119,061

(22) Filed: May 12, 2008

(51) Int. Cl. H04M 1/00

(52) U.S. Cl. 455/556.1

(57) ABSTRACT

A portable electronic device includes a motion sensor sensing motion inputs to the device, a haptic output device, including one or more haptic devices, providing force feedback representing interpretation of motion of the device, and a processor responsive to a motion input as sensed by the motion sensor as a representation of motion of the portable electronic device, and wherein the haptic output device provides a haptic output as feedback indicating how the motion is interpreted by the portable electronic device without the need for a user of the device to look at the display of the device. The haptic output may represent whether a telephone call has been completed or the called telephone is busy. A method of indicating the result of motion or of selecting of a function of a portable electronic device and providing haptic output representative thereof as feedback without the need to view the device display.

### TECHNICAL FIELD

The present invention relates generally to electronic equipment and use of directional force feedback to identify functions or results of motion of the electronic equipment and method and, more particularly, to haptic output as feedback of interpretation of motion input to a portable electronic device and method.

### BACKGROUND

Mobile and/or wireless electronic devices are becoming increasingly popular. For example, mobile telephones, portable media players and portable gaming devices are now in wide-spread use. In addition, the features and accessories associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces. Exemplary accessories may also include headphones, music and video input players, etc.

Motion has been used as an input to portable electronic devices to initiate a function of the device. For example, exchange of information between a pair of portable electronic devices may be carried out by moving a pair of portable electronic devices together in a common path, e.g., shaking them together. Shaking also has been used to navigate through a database of songs, e.g., a list of song titles, in a portable electronic. In these portable electronic devices it usually is necessary for a user to observe the display screen of the device to know whether the intended information exchange is being carried out, what song has been selected, etc.

### SUMMARY

Briefly, the present invention provides haptic output (also sometimes referred to below as “haptic feedback”) for a portable electronic device. The haptic output may represent various information, such as, for example, how the portable electronic device interprets a motion input, functional operation of the device in response to a motion input, and/or other information. The haptic output may represent operation of the portable electronic device, such as, for example, motion effects as starting, stopping, or turning in the process of the playing of a game using the portable electronic device.

Briefly, in accordance with one aspect of the present invention a portable electronic device includes a control responsive to an input to the portable electronic device, and a haptic output device adapted to provide a haptic output representing interpretation of the input to the portable electronic device by the control.

Another aspect relates to said haptic output device comprising a plurality of haptic devices operable by the control in cooperative relation to provide a tactile sense of movement in a direction.

Another aspect relates to said haptic devices being cooperable to provide a tactile sense of rotational motion of the portable electronic device.

Another aspect relates to the control comprising a motion sensor and a processor.

Another aspect relates to the control comprising a memory and program code used by the control to carry out functions of the portable electronic device.

Another aspect relates to the haptic output device adapted to respond of the control to provide a haptic output for the portable electronic device representing the interpretation of motion by the control to carry out respective functions of the portable electronic device.

Another aspect relates to the control comprising circuitry to provide to the haptic output device a signal that has a relatively steep slope to rapidly cause the haptic output device to provide a tactile output and a subsequent relatively gradual slope to allow the haptic output device to return relatively gradually to a relatively resting mode after the having provided a haptic output.

Another aspect relates to said haptic output device providing linear motion output.

Another aspect relates to the portable electronic device having a number of functions, wherein the control is responsive to motion of the portable electronic device to navigate to or through such functions, and wherein the haptic output device provides an output representing the extent, if any, of such navigation.

Another aspect relates to the portable electronic device comprising a game, and the haptic output device provides haptic output representing at least one of interpretation of movement as input to the game or output information relevant to the game.

Another aspect relates to wherein the haptic output device provides a relatively upward motion to the portable electronic device to represent a positive response and a relatively downward motion to the portable electronic device to represent a negative response.

Another aspect relates to wherein the portable electronic device is cooperable with another portable electronic device to communicate therewith, and the haptic output device provides a haptic output representing such communication.

Another aspect relates to wherein the portable electronic device includes a function that occurs upon tilting, and wherein the haptic output device provides a tilting motion as a representation that the function is being carried out.

Another aspect relates to wherein the portable electronic device comprises a mobile phone.

Another aspect relates to wherein the control is responsive to an input representing completing of a phone call to another phone or a busy condition of a called phone, and the haptic output device provides a haptic feedback representing such input.

Another aspect relates to said motion sensor comprising an number of accelerometers.

Another aspect relates to said haptic output device comprising a motor, coin motor, vibrating motor or vibrator adapted to provide force feedback that is linearly directional, rotational or tilting.

Another aspect relates to a method of indicating the result of selecting a function of a mobile device in response to an input to the mobile device or completing a telephone call or a called telephone busy condition, including providing haptic feedback representative of such input.

Another aspect relates to further comprising moving the mobile device to select a function among a grid of functions or an item in a list of items, and wherein the haptic feedback represents interpretation of such moving.

Another aspect relates to, said providing haptic feedback comprising providing force feedback to give a sensation of a bump or thump, a linear motion, a tilting motion or a rotation.

Another aspect relates to a portable electronic device, including a motion sensor, a haptic output device, and a processor responsive to a motion input as sensed by the motion sensor as a representation of motion of the portable electronic device, and wherein the haptic output device provides a haptic output as feedback indicating how the motion is interpreted by the portable electronic device.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

In the annexed drawings:

FIG. 1 is a schematic isometric illustration of a portable electronic device, e.g., in the form of a mobile phone;

FIG. 2 is a schematic side elevation view of the portable electronic device of FIG. 1;

FIG. 3 is a block system diagram of circuitry and associated parts of the portable electronic device for carrying out operation thereof in a manner described below;

FIG. 4 is a simplified block diagram of a portable electronic device including a haptic output device in accordance with a general embodiment of the invention;

FIG. 5 is a schematic block diagram illustrating a list of selectable songs on a display of a portable electronic device;

FIG. 6 is a schematic block diagram illustrating a graphical user interface (GUI) of a portable electronic device;

FIG. 7 is a schematic illustration of a pair of mobile phones arranged for shaking or other moving together;

FIG. 8 is a schematic flow chart illustrating exemplary logic and method according to which the invention may operate;

FIG. 9 is a schematic illustration of a portable electronic device with a controller and a number of haptic devices and motion sensors;

FIG. 10 is a schematic logic diagram or flow chart illustrating exemplary operation of the portable electronic device; and

FIG. 11 is a schematic logic diagram or flow chart illustrating exemplary operation of the portable electronic device for playing a game.

### DESCRIPTION

The interchangeable terms “electronic equipment” and “electronic device” include portable radio communication equipment. The term “portable radio communication equipment,” which hereinafter is referred to as a “mobile radio terminal,” as “portable electronic equipment,” or as a “portable communication device,” includes all equipment such as mobile telephones, pagers, communicators, electronic organizers, personal digital assistants (PDAs), smartphones, portable communication apparatus or the like.

In the present application, embodiments of the invention are described primarily in the context of a portable electronic device in the form of a mobile telephone (also referred to as “mobile phone”). However, it will be appreciated that the invention is not intended to be limited to the context of a mobile telephone and may relate to any type of appropriate electronic equipment, examples of which include a media player, a gaming device, PDA and a computer, etc.

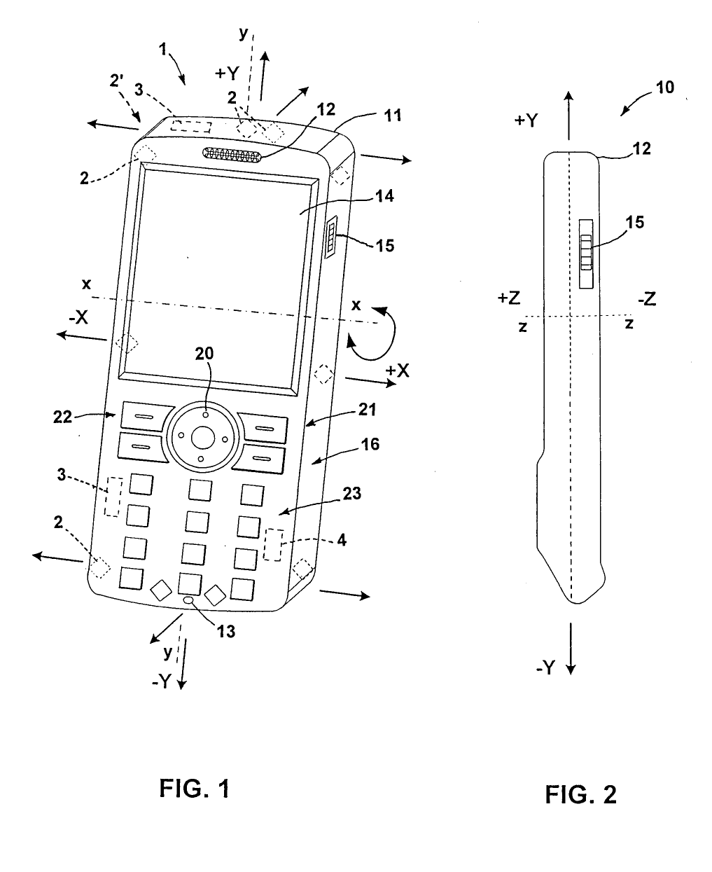

Referring in detail to the drawings, and initially to FIGS. 1 and 2, a portable communication device in accordance with an embodiment of the present invention is illustrated generally at 1 including a haptic output device generally designated 2′; the haptic output device may be one or more haptic devices 2. In the interest of brevity and for convenience of the description below, reference to “haptic output device” means one or more haptic devices 2 and, similarly, reference to haptic device 2 may include one or more than one haptic device. As is described further below, the haptic output may be used to solve the problem of feeding back information to the hand of a user of a handset, e.g., the mobile phone 1, of how the handset interprets movements, as is described further below.

The portable communication device 1 will be referred to below as a mobile phone. However, as was mentioned above, reference to “mobile phone” includes various other devices, such as, for example, those mentioned above. In outward appearance, for example, as is illustrated in FIGS. 1 and 2, the mobile phone 1 includes a case that is of one type of design, style or form factor; however, the features of the invention, as are described in further detail below, may be used in other types of mobile phones, such as those that include cases that open and close (sometimes referred to as a “flip phone”) by rotating one part relative to another, slide phones in which one part of the case slides relative to another, and various other mobile phones that currently exist or may come into existence in the future.

Shown in FIGS. 1 and 2 are a number of axes labeled x, y and z. These axes are illustrated in relatively orthogonal relation, but they may be in other relation and/or there may be further axes. The mobile phone 1 includes one or more haptic devices 2 that are operable to provide haptic output representing information that can be understood by a user. The haptic output may be of a type that provides a tactile feeling, force feedback or a motion or a sensation, e.g., by pressure, a thump or bumping sensation, an actual movement, etc., that can be sensed by a user of the mobile phone (also referred to herein simply as “user”). Several examples of haptic devices 2 are coin motors, micro motors, vibrators and vibration motors; and these or other haptic devices may be used in accordance with the invention. For example, the haptic output may provide a sensation of motion to the left or right along the x axis, as is represented by the direction arrows +X and −X, respectively. Similarly, motion may be up or down in the +Y or −Y direction along the y axis; or forward or back along the z axis in the +Z or −Z direction, respectively. Still further, the sensed motion of the haptic output may be a rotational, tilting, swiveling, turning or pivoting motion, e.g., about any of the x, y or z axes, one example of which is represented by the arrow X′ depicting rotation about the x axis. The terms rotational, tilting, swiveling, turning, pivoting and the like may be used equivalently and interchangeably herein. The haptic output may be in a different direction than those described or illustrated, as will be appreciated. The number of haptic output directions for the mobile phone 1 may depend on the number of haptic devices, type of haptic devices, e.g., ability to provide haptic output in one or more directions, location of the haptic devices 2 in or with respect to the mobile phone, directional orientation of the haptic devices, and extent of cooperation or cooperative action of the haptic devices.

Circuitry for operating the haptic devices 2 may be a type that provides a driving signal for a haptic device such that the driving signal quickly increases magnitude, e.g., is a step function or has a steep curve at the outset, to obtain operation of the haptic device to provide tactile sensation or force feedback output, etc. The driving signal may have a relatively more gradual return to a zero level or rest condition for the haptic device so that as the zero level or rest condition is achieved it has relatively small inertial effect and is not sensed by the user or is not sensed to the same extent as is the driving signal first applied to obtain the haptic output.

Since the haptic device 2 may provide a tactile sensation, e.g., one that can be sensed using the sense of touch or feeling of force or motion, etc., a user may not have to view the display or other portion of the mobile device to understand the information that the haptic output is providing.

The haptic output may be provided for one or more purposes. One exemplary purpose is to provide a representation to the user concerning interpretation of an instruction given to the mobile phone. For example, the mobile phone may be a type that carries out a function in response to motion applied to the mobile phone. An example may be shaking the mobile phone to navigate in a list, such as a list of songs, e.g., to move up or down in the list of songs that can be selected to be played by the mobile phone 1 or by some other portable electronic device, for example, as was mentioned above. A “small shake” may not have enough motion or acceleration to be interpreted by a motion sensor in the mobile phone as a shake that means to move even one song in a list; a “one song shake” may have sufficient motion or acceleration to move up or down one song in the list, depending on the directional characteristics of the shake; and a “large shake” may have motion or acceleration to cause moving up or down more than one song in the list. The haptic feedback provided by the haptic device(s) 2 may indicate to the user how the shaking was interpreted and/or used by the mobile phone, e.g., no moving in the list, moving one song, moving more than one song, and the direction of moving, if any, in the list of songs. Shaking may be used to navigate among functions, e.g., those displayed in a graphical user interface (GUI) display of functions shown on the display of the mobile phone 1. Shaking may be used to transfer data between two mobile phones. Shaking may be used to navigate in an hierarchical structure of a database or of another collection of functions, data, etc.

One or more motion sensors 3, e.g., accelerometers or other motion sensors, may be used by the mobile phone 1 to detect the acceleration, speed, movement, motion and/or distance of movement or motion, etc., e.g., due to shaking or other motion of the mobile phone. The terms acceleration, speed, movement, motion, distance of movement and/or motion may be used interchangeably, or if context dictates, specifically to the meaning of the given term; and when such terms are used interchangeably and in effect equivalently, they may be referred to collectively herein simply as “motion” or as one of the others of those mentioned terms or equivalent terms. The terms accelerometer, motion sensor, and the like may be used equivalently and interchangeably herein, or if context dictates, specifically to the meaning of the given term. The accelerometer or other motion sensors may be conventional devices that detect such motion and provide an output, e.g., an electrical signal, representing such motion.

Operating circuitry 4 of the mobile phone 1 may interpret such motion and determine operation or function of the mobile phone accordingly. For example, if the motion were inadequate to select a function or to navigate to or to move in a list of songs, etc., there may be no change in current operational status of the mobile phone; in such case there may be no or may be some specific type of haptic feedback indicating the same. If the motion caused movement from one song to the next song in a song list or from one function in a GUI to an adjacent function, the haptic feedback may be a single tactile pulse, e.g., thumps, bumps, movement, etc.; and that single tactile pulse may be directionally oriented or directed to indicate the direction of movement in the list or GUI. If the motion caused movement more than one song in the list, e.g., skipping one or more songs between the prior song to the newly selected song, or from one function in a GUI to another function while skipping over a function, then the haptic feedback may be two tactile pulses; and, as was mentioned above, the haptic feedback may be directional. If more than one song, function, etc. were skipped over, there may be, for example, correspondingly more than two tactile pulses.

The cooperative operation of the haptic device(s) 2, motion sensor(s) 3 and operating circuitry 4 in a sense may be used to “visualize physically” moving up and down in a list view of a user interface, e.g., a list of songs. If a user shakes the mobile phone to move down in the list, the force feedback provided by the haptic device(s) can be used to simulate a “negative notch” in the list. Similarly, moving up the list can make the user feel a “positive notch.” Thus, the user can be made to feel in which direction the simulated “notch” is being crossed. In this way the user can, for example, scroll via shaking down one or more rows in an address book or list of songs, etc., without looking at the display of the mobile phone 1; the haptic feedback provides information to indicate to the user the result of such shaking. The same type of haptic feedback can be generalized to moving in all directions in a grid of icons, such as a GUI, or in another user interface and providing force feedback indicating the result of such moving. The haptic output or haptic feedback provided by the haptic devices 2 as operated in the mobile phone 1 may simulate physical movement when operating a user interface.

The portable electronic device, e.g., the mobile phone 1, may be used in playing a game. For example, the game may be of a type that uses directional inputs and/or outputs, and the haptic feedback may be used to provide tactile information to the user. The tactile feedback may represent the moving of a vehicle in a curved path, such that the portable electronic device tends to provide a sensation of tilting or if not held securely may actually tend to tilt. The haptic output may be a directional movement representing increase in speed of a vehicle in the game or may be a sharp stop sensation representing a vehicle crash, etc.

For brevity the invention is described by example with respect to a list of songs or with respect to a GUI. However, it will be appreciated that the invention may be used with other lists, e.g., lists of tasks, appointments, contacts, groceries, etc.; and the invention may be used with functions other than those represented by icons in a GUI. Other uses of the invention also will be apparent to persons having ordinary skill in the relevant art.

The portable electronic device 1 may be any of many different types of such devices. As a mobile phone 1, for example, the portable electronic device includes case (housing) 11, speaker 12, microphone 13, display 14, e.g., liquid crystal display, light emitting diode display, or other display, on/off switch 15, and a number of keys generally indicated at 16. The keys 16 may include a number of manually operable keys having different respective functions. For example, the key 20 may be a navigation key, selection key or some other type of key; the keys 21, 22 may be, for example, one or more soft switches or soft keys; and the keys 23 may be dialing keys. As an example, the navigation key 20 may be used to scroll through lists shown on the display 14, to select one or more items shown in a list on the display 14, etc. The soft switches 21, 22 may be operated to carry out respective functions, such as those shown or listed on the display 14 in proximity to the respective soft switch or selected by the navigation key 20, etc. The display 14 may include a GUI that shows a number of different icons representing respective functions, applications or the like (collectively referred to as functions herein), e.g., email, calendar, contacts, messages, games, etc., and the navigation key 20 may be used to point to a given function and either the navigation key or the soft keys, for example, may be used to select the function to cause it to carry out its task or the like. The soft keys 21, 22 may be used to initiate a phone call, e.g., to connect to a wireless telephone circuit and to transmit a telephone number, etc., to answer an incoming phone call, to transmit a text message, etc., to end a phone call, and/or to carry out other functions.

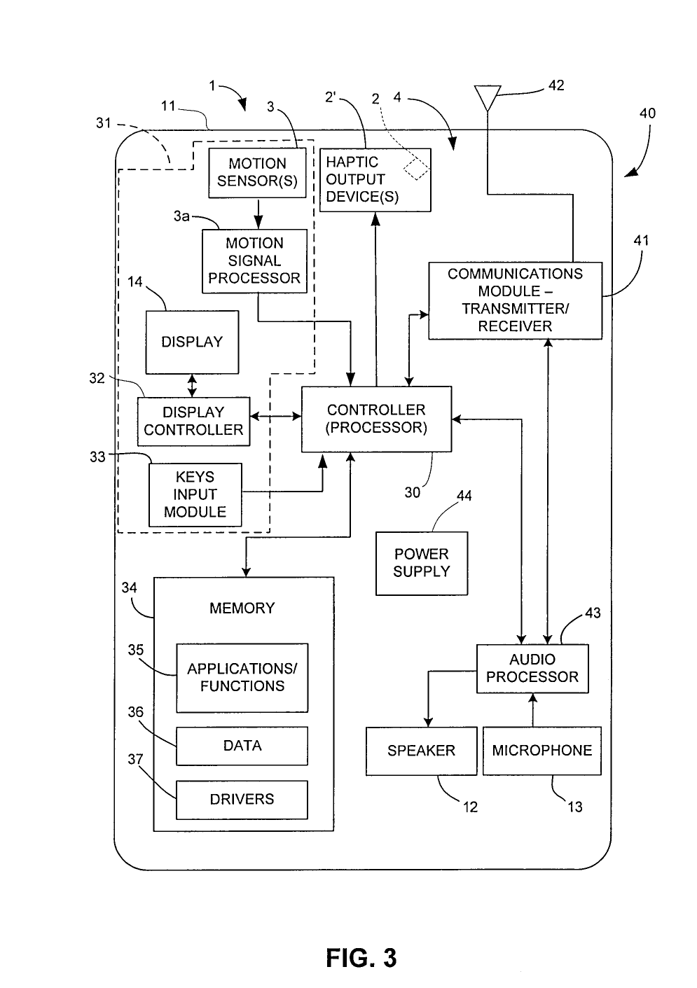

The dialing keys 23 may be used to dial a telephone number or to input alphanumeric or other data. The speaker 12, microphone 13, display 14, and keys 16 may be used and function in the usual ways in which a mobile phone typically is used, e.g. to initiate, to receive and/or to answer telephone calls, to send, to receive and to review text messages and email, to connect with and carry out various functions via a network, such as the Internet or some other network, to beam or otherwise to transfer information between mobile phones, to access a database and to enter or to retrieve information with respect to the database, etc. These are examples; there may be other uses that currently exist or may exist in the future. The mobile phone 1 also includes operating circuitry 4 (schematically illustrated in FIG. 1 and shown in further detail in FIG. 3) that responds to programming and to inputs, e.g., provided by a user pressing a key or applying a stylus or finger to a touch-sensitive screen of the display 14, shaking or moving the mobile phone, etc. or provided from an external source, such as an incoming telephone call or text message, to carry out functions of the mobile phone.

Turning to FIG. 3, a schematic block diagram of the operating circuitry 4 of the mobile phone is illustrated. The illustration is exemplary; other types of circuitry may be employed in addition to or instead of the operating circuitry 4 to carry out the haptic feedback functions and the various telecommunication and other functions of a mobile phone. The operating circuitry 4 includes a controller 30 (sometimes referred to as a processor or as an operational control) that receives inputs and controls the various parts and operation of the operating circuitry. The controller 30 may include, for example, a processor, such as a microprocessor, associated logic circuitry and input/output circuitry. An input module 31 provides inputs to the controller 30. The input module includes, for example, one or more motion sensors 3, a display controller 32, and a keys input module 33.

The motion sensors 3 may be conventional accelerometers, motion detectors, distance and/or speed sensing devices, etc., that provide suitable signals to the controller 30 directly or via motion signal processor 3a to represent shaking or other motion of the mobile phone 1. The motion sensors 3 alone or with the motion signal processor 3a may include suitable signal conditioning, adjusting, threshold detection, etc. circuitry to provide signals to the controller 30 that are suitable to represent motion, shaking, etc. of the mobile phone, for interpretation by the controller to carry out or to control various functions, etc. of the mobile phone 1.

The display controller 32 receives inputs from the controller 30 to cause images, information, etc., to be shown on the display 14. If the display 14 is a touch sensitive display, the display controller 32 responds to inputs from the touch sensitive display or from another type of display that is capable of providing inputs to the controller. Thus, for example, touching of a stylus or a finger to a part of a touch sensitive display, e.g., to select a song in a displayed list of songs, to select a contact in a displayed list of contacts, to select an icon or function in a GUI shown on the display, etc., may provide an input to the controller 30 in conventional manner.

The keys input module 33, for example, may be the keys 16 themselves and/or may be signal conditioning, decoding or other appropriate circuitry to provide to the controller 30 information indicating the operating of one or more keys 16 in conventional manner.

A memory 34 is coupled to the controller 30. The memory may be a solid state memory, e.g., read only memory (ROM), random access memory (RAM), SIM card, etc., or may be another type of memory. The memory 34 may be part of the controller 30. The memory 34 may include an applications or functions storing section or function 35 to store applications program and function programs or routines for carrying out operation of the mobile phone 1 via the controller 30. The memory 34 also may include a data storage section or function 36 to store data, e.g., contacts, numerical data, music, video, pictures, and/or virtually any other data for use by or in the mobile phone 1. A drivers section 37 of the memory 34 may include various drivers for the mobile phone 1, e.g., for communication functions and/or for carrying out other functions of the mobile phone.

The mobile phone 1 includes a telecommunications portion 40. The telecommunications portion 40 includes, for example, a communications module—transmitter/receiver 41, e.g., a radio, that receives incoming signals and transmits outgoing signals via antenna 42. The communications module—transmitter/receiver 41 is coupled to the controller 30 to provide input signals and data and to receive output signals and data, as in conventional mobile phones. The terms signals, data, audio data, etc., may be used equivalently and interchangeably herein or may be specific to the immediate description as will be evident from context. The communications module—transmitter/receiver 41 also is coupled to the speaker 12 and microphone 13 via an audio processor 43 to provide audio output via the speaker and to receive audio input from the microphone for usual telecommunications functions. The speaker 18 and microphone 20 enable a user to listen and to speak via the mobile phone 1. Audio data may be passed to the audio processor 43 from the memory 34 via the controller for playback to the user. The audio data may include, for example, audio data from an audio file, e.g., a song, another recording, a video, etc., stored in the memory 34 and retrieved by the controller 30. The audio processor 43 may include appropriate buffers, decoders, amplifiers and the like. A power supply 44, e.g., a battery or a connection to an external power source provides electrical power to the various parts of the mobile phone 1.

For telecommunication functions and/or for various other applications and/or functions as may be selected from a GUI shown on display 14 or otherwise selected, for example, the mobile phone 1 may operate in a conventional way. For example, the mobile phone may be used to make and to receive telephone calls, to play back songs, pictures, videos, movies, etc., to take and to store photographs or video, to prepare, to save, to maintain, and to display documents and databases such as a contacts or other database, to browse the Internet, to maintain a calendar, to send and to receive text messages, etc.

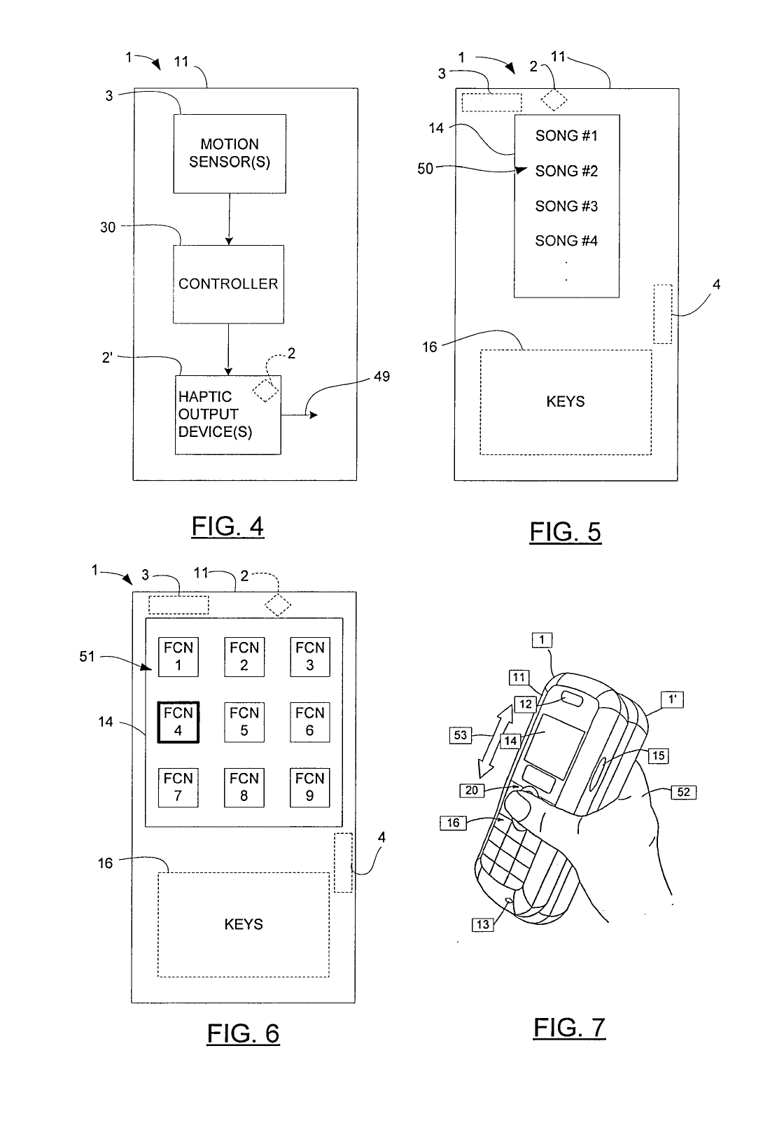

The use of haptic device(s) 2 to provide a haptic output representing operation of the mobile phone 1 and/or interpretation of motion of the mobile phone may be controlled by the controller 30. For example, in response to a signal from one or more motion sensors 3 the controller 30 may determine information about motion of the mobile phone 1 and based on interpretation of that motion information may cause one or more the haptic devices 2 to provide a haptic output (also referred to as tactile output) representing the motion and/or the manner in which the controller 30 and/or other part(s) of the mobile phone 1 are responding, did respond, or are expected to respond to such motion input. Several examples of such operation are described below with respect to FIGS. 4-7.

Referring to FIG. 4, a simplified block diagram illustrating a portable communication device in the form of a mobile phone 1 is illustrated. The motion sensor(s) 3 may sense or detect motion of the mobile phone and provide an input to the controller 30 as a representation such motion. The controller 30 responds to that input representing motion and provides an output to the haptic device(s) 2. The haptic device(s) provide a haptic output or tactile output (represented by arrow 49) for the mobile phone, e.g., by applying a force directly or indirectly to the case 11 of the mobile phone, or by providing an inertial movement, force, acceleration, etc. sensation to the mobile phone to be sensed by a user, etc. According to an embodiment the controller 30 responds to the motion to carry out a task such as to scroll up or down in a list of songs that are shown on the display 14, to move from a graphically illustrated function or icon on a GUI shown on the display 14 to another function or icon shown on the display, or otherwise to effect some kind of navigation through lists, tasks, functions, icons, etc. The haptic output 49 may be felt by the user by the sense of touch, e.g., a bump or thump against the case by a haptic device or by a rotation or twisting force applied to the case that can be felt by the user, by an up, down, sidewise, etc., motion of the mobile phone that can be felt by the user, etc.

In the example illustrated in FIG. 5 and with continued reference to FIG. 4, a list of songs 50 is shown on the display 14. The user may intend to shake the mobile phone 1 sufficiently to move from one song to select the next song in the list. If the shake is appropriate, the haptic device 2 will be controlled by the controller 30 to provide a haptic output that can be felt or sensed by the user as an indication that the controller has interpreted the shake to be sufficient to move one song in the list and that the new song has been selected or pointed to; and this information may be conveyed by the haptic feedback without the need for the user to view the display 14. The haptic output may be a single thump, bump or motion in a relatively upward or downward direction relative to the top and bottom of the mobile phone so that the user will be informed in which direction the movement in the list had occurred. The foregoing information can be conveyed to the user without the need for the user to divert visual attention to the display 14, e.g., without the need to look at the display. Similarly, if the shake were sufficiently strong and/or the motion were for a sufficient distance, etc. greater than that needed to move one song in the list, perhaps being sufficient to move two or more songs in the list, the haptic output may indicate the same by providing two or more bumps, thumps, or other haptic output indicating the respective number of songs through which movement had occurred in the list of songs, e.g., two songs (skipping one song between the prior song and the newly selected song), three songs (skipping two songs between the prior song and the newly selected song), etc. The motion may be too small to move in the song list, and in this example the haptic output may be null, e.g., no haptic output (or some other defined haptic output), so that the user will know that there has been no change in the song that had been pointed to or selected prior to the shaking or other movement. Although the list 50 is of songs, it may be of other selectable data, information, programs, functions, tasks, contacts, etc.

Referring to FIG. 6, another exemplary use of the invention is illustrated schematically. A graphical user interface (GUI) 51 is shown on the display 14 of the mobile phone 1. The GUI shows nine function icons labeled one through nine, each representing an exemplary function; in a typical GUI each icon would include an image and/or wording representing the function represented by that icon. To simplify the drawing, no specific name or graphic is shown in the illustration as being associated with the respective functions of the GUI 51, but they may be, for example, icons representing, respectively, information about or a tour of the mobile phone features, set up of the mobile phone, initiate phone call functions, email, calendar, camera, contacts, documents, messaging, task list, voice memo, world clock, Internet connection, etc. Other icons and/or functions may be shown in the GUI on the display 14.

In the illustration of FIG. 6 function icon No. 4 is highlighted as though it had been selected or is being in a sense pointed to. The user may shake the mobile phone 1 laterally in a given direction, e.g., in a direction along the x axis (FIG. 1) toward function No. 5, and if the shaking were sufficient, the prior function icon No. 4 would become unhighlighted and function icon No. 5 would become highlighted and, thus, be the newly selected icon. If the mobile phone 1 were shaken laterally with greater force or over a further distance, etc. toward the function icon No. 5, the function icon No. 6 may become highlighted, whereby from the prior function icon No. 4 the highlighting and, thus, the selecting of a function icon would skip over function icon No. 5 and function icon No. 6 would be the newly highlighted and, thus, selected function icon. Similar operation to move or to select any of the respective function icons of the GUI 51 may be achieved by shaking the mobile phone in respective directions parallel to the display 14 vertical and horizontal directions, e.g., in a direction along the x or y axes (FIG. 1), or relatively diagonally to the display, with respective amounts of force, acceleration, distance, etc. to achieve a desired result. The haptic feedback function may be provided by one or more haptic devices 2 that are operated by the controller 30. The haptic devices 2 provide haptic output indicating how the controller interpreted the above-mentioned shaking to move in the GUI to select different respective function icons.

After the motion had caused moving in the list of songs 50 or in the functions of a GUI the user may press a key to carry out playing of the song, the application of the function pointed to in the GUI, etc. Other means may be used to effect playing of the newly selected song or function, e.g., based on a timer, based on a subsequent shaking of the mobile phone, etc. Shaking also may be used to turn on or to turn off the mobile phone 1 or a given feature or function of the mobile phone, e.g., the telecommunications function, turning on or off illuminating or operation of the display 14, changing brightness and/or volume of the mobile phone, etc.

Briefly referring to FIG. 7, a pair of mobile phones 1, 1′ is shown in the hand 52 of a user. In this application of the invention, the action of transferring a file, data, etc., may be started by NFC and Bluetooth as a bearer; the haptic feedback provided, as is described further below, augments such transfer by applying a tilting force, thus giving a feedback that file transfer is occurring. The mobile phones are oriented in the same direction. The user may shake both of the mobile phones 1, 1′ while holding them; arrow 53 represents such shaking in a direction generally parallel to a length dimension of the mobile phones. The mobile phones 1, 1′ are of the type that upon being shaken in the direction of the arrow 53, either just in one direction or in a repetitive manner, e.g., back and forth, as is represented by the double headed character of the arrow 53, information, data, etc., will be transferred from one mobile phone to the other or from each mobile phone to the other. If necessary, appropriate manual settings may be made on one or both of the mobile phones 1, 1′ to prepare them to carry out the transfer in response to the shaking. In accordance with this embodiment of the invention, the motion sensor(s) 3 may sense such shaking and if it is appropriate motion as determined, for example, by the controller 30, the controller may cause the haptic device(s) 2 to provide a haptic feedback such as a thump, bump, or motion in a given direction, e.g., in the direction of shaking, to indicate to the user that the shaking has been interpreted properly and data is, will be or has been transferred.

The pair of mobile phones 1, 1′ or of one relative to the other may be a type of motion that would be intended to transfer a file or other data, etc. from one mobile phone to the other. The haptic output provided by the haptic device(s) could be provided to apply a tilting force to one or both mobile phones to give a feedback that file transfer is to occur or is ongoing.

Another exemplary use of the present invention would be to provide an upward tilt as a positive response or motion and a downward tilt as a negative response in the course of operating the mobile phone 1 and/or an application thereof. For example, this can be used in call control, whereby upward tilt would mean call connected and downward tilt would mean that the call was rejected or busy. It will be appreciated that in this and other examples of using the present invention the haptic feedback provides information to the user without the need for the user to look at the display of the mobile phone or to listen to sounds from the speaker, e.g., to get feedback on connection status for a phone call. Vibrators have been used in mobile phones to indicate an incoming phone call or as an alarm. The haptic device(s) 2 may be used instead to provide haptic feedback in response to completing a phone call or to a busy signal and, therefore, to indicate such completing or busy. Thus, it will be appreciated that the completing of a phone call or the occurrence of a busy signal may be an input to the mobile phone; motion also may be an input to the mobile phone; and the mobile phone is able to provide haptic feedback representing the result or interpretation of such input.

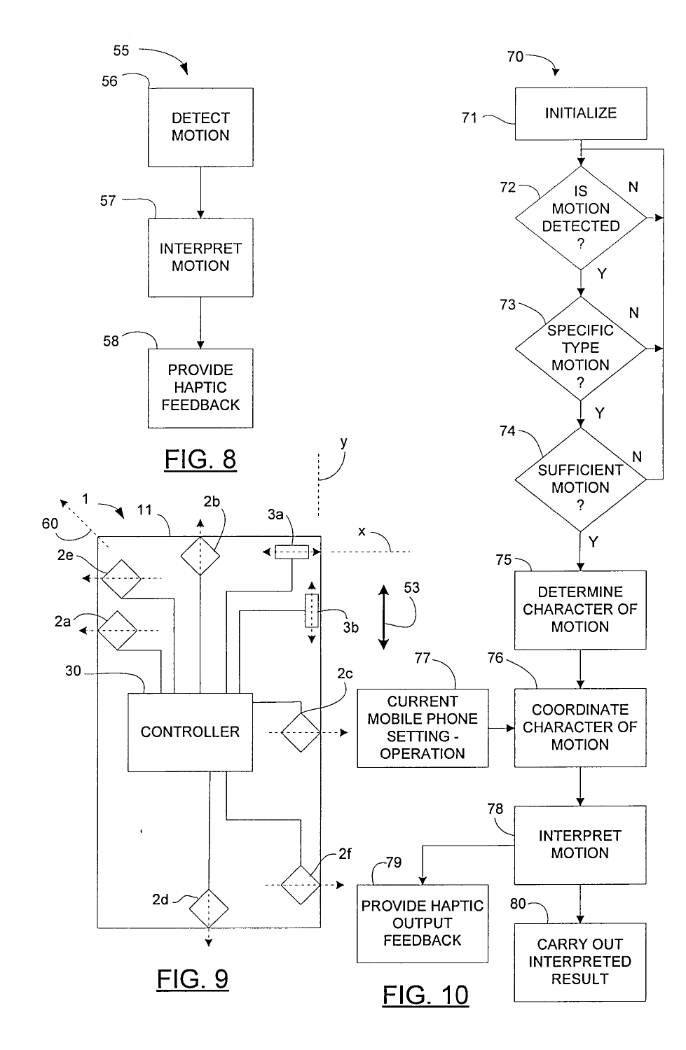

Turning to FIG. 8, a schematic function diagram or logic diagram 55 illustrating a method of operation of the invention is illustrated. At block 56 motion is detected, e.g., in the embodiment of FIG. 7, the shaking motion of the mobile phones 1, 1′ is detected by respective accelerometers in the mobile phones. At block 57 the character of the motion is interpreted. For example, if the motion were linear shaking repeatedly in the direction of the arrow 53 (FIG. 7), that might lead to transferring of data from one mobile phone to the other. Alternatively, if the character of the motion were different, e.g., a rotating motion as in the direction of the arrow X′ of FIG. 1, that might lead to interpretation of motion to cause exchanging of date from each of the mobile phones to the other of the mobile phones. As still other examples, a single shake in a single direction, e.g., along an axis y (FIG. 1), say in the direction of the arrow +Y, may cause transfer of data from the mobile phone 1 to the mobile phone 1′; and a single snake in the direction of the arrow −Y may cause transfer of data from the mobile phone 1′ to the mobile phone 1. These are but a few examples of how shaking in different respective directions and with different repetitions, distances, and/or force, etc. may be sensed by the motion sensor(s), interpreted by the mobile phone, e.g., by the controller 30 with appropriate programming from memory 34, and used as inputs to the mobile phone. Other examples mentioned above include shaking the mobile phone to move in a list or to move in a GUI, etc. Continuing to refer to FIG. 8, after the motion has been interpreted at block 57, then at block 58 a haptic feedback is provided by the mobile phone to indicate to a user the interpretation of the motion. Based on such interpretation of the motion, the mobile phone may carry out a given function, e.g., transfer data, select a song, select an icon in a GUI, etc.; and the haptic feedback may represent the results of such interpretation, e.g., indicating that the result had been carried out, is being carried out, or will be carried out.

FIG. 9 shows schematically an outline of a mobile phone 1 with several haptic devices, for example, six haptic devices 2a-2f and several motion sensors, for example, two motion sensors 3a, 3b. The motion sensors 3a, 3b are accelerometers that sense acceleration motion in a direction parallel to the x axis or parallel to the y axis, respectively. The x axis and the y axis of the mobile phone 1 are represented by phantom lines designated, respectively, by the letters x and y. For example, relative to the illustration of FIG. 7, the acceleration motion in the direction parallel to the y axis direction may be in the direction of the double headed arrow 53. Signals from the accelerometers 3a, 3b are coupled to the controller 30, which may interpret the motion to determine the character of the motion, e.g., the direction, the speed, the acceleration, the number (such as the number of shakes), whether the detected motion is sufficient to be considered for causing an operation of the mobile phone, etc. Double headed phantom arrows illustrated in the accelerometers 3a, 3b represent the direction of acceleration motion that may be sensed by those accelerometers, e.g., acceleration motion in directions parallel to the x axis and y axis, respectively. In response to such interpretation of the character of the detected motion, the controller 30 may cause a corresponding operation of the mobile phone 1. The controller provides signals to the respective haptic device(s) 2a-2f to provide haptic output for the mobile phone. For example, sufficient shaking (acceleration or other motion) in the direction of the y axis in an upward direction that causes moving upward in a list of songs may lead to the controller 30 operating the haptic device 2b to provide a thump, bump, motion, etc., in the direction +Y (FIG. 1) also represented by a phantom arrow in the haptic device 2b; similar phantom arrows representing the direction of haptic output force are illustrated at the other haptic devices 2a, and 2c-2f in FIG. 9. Shaking in both directions along the y axis, e.g., up and down as represented by double headed arrow 53, may be interpreted to cause the mobile phone 1 in FIG. 7 to provide a prescribed function, e.g., to transfer data to the other mobile phone 1′, and the controller then may control operation of the haptic devices 2b, 2d to provide haptic output sequentially in both directions along the y axis. In another circumstance the controller 30 may operate one of the haptic devices 2a or 2c to provide a haptic output force in a direction that is generally parallel to the x axis, respectively, in either the −X or +X direction shown in FIG. 1. As still another example, the controller may operate two haptic devices 2a and 2b simultaneously to provide a diagonal haptic output force in a direction approximately forty-five degrees between the x axis and the y axis as is represented by the phantom arrow 60. Furthermore, the controller may operate several, e.g., two or more, of the haptic devices 2a, 2b, 2c and 2d a sequential manner, e.g., with a small time difference between actuations of the haptic devices, to provide sequential haptic output forces to provide a sensation of a rotating effect. For example, operating the haptic devices in serial sequence 2a, 2b, 2c, 2d would provide a sense of rotation of the mobile phone about the z axis (FIG. 1). Still another possibility to provide a rotating or tilting sensation by haptic output may be use two haptic devices 2e and 2f that are located near respective corners of the housing 11 to provide a force couple in the direction of the phantom arrows therethrough. Depending on the position and orientation of the haptic device(s) 2 in the mobile phone, e.g., relative to the case 11, and the direction and timing of output force provided by one or more haptic device(s), the haptic device(s) may apply a torque to the mobile phone tending to cause a rotation of the mobile phone about an axis, e.g., about one of the axes x, y or z or about another axis. Such torque tends to provide a tactile feedback to the user as rotational feedback or output, e.g., whereby the mobile phone actually undergoes a rotation, or the torque may be felt by the user's hand 52 giving a sensation of a rotational tactile feedback.

It will be appreciated that by using a plurality, e.g., at least two, haptic devices 2, the user may feel the sensation of the mobile phone 1 or other handset moving in the user's hand. Using different combinations of force directions and amplitudes of the haptic devices 2, different respective motions may be provided the user as haptic feedback to represent respective feedback information.

A power supply 49 provides electrical power to the operating circuitry 4 and/or to other parts of the mobile phone 1 via the on/off switch 15. The power supply may be a conventional battery or some other source of electrical power. Upon closing the on/off switch 15, the power is provided the operating circuitry 4 to carry out the various functions described herein, for example. If desired, closing the switch 15 may lead to temporary operation of the display to display a start-up message or indication, and then a power saving feature, e.g., a screensaver function, may be implemented to turn off the display.

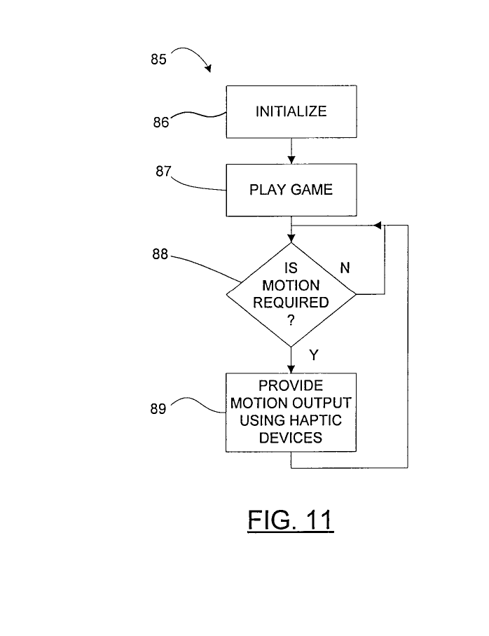

In FIG. 10 a computer program flow chart or logic diagram is illustrated at 70. Such flow chart 70 represents functions that may be carried out in the operating circuitry 4 in carrying out an embodiment of the invention as an example. The functions illustrated in FIG. 10 and described herein with regard to respective “blocks” that may represent steps in a computer program or a method, for example, may be provided the operating circuitry as a computer program, for example, that is written in appropriate computer language or logic format to carry out the various steps described. A person having ordinary skill in the art would be able to write such program to carry out the steps and functions illustrated and described here. It will be appreciated that the program code may be stored in a storage medium, e.g., in the memory 34. For example, as is described, the program code may include a computer program that recognizes motion inputs represented by signals from the motion sensors 3, interprets such motion inputs, and provides haptic feedback in response thereto as a representation of the interpretation or of the function, etc. that was, is being or is intended to be carried out.

Initially at block 71 the portable electronic equipment, e.g., mobile phone 1, is turned on and the operating circuitry 4 is initialized. Turning on may be by the power switch 15 or, if the mobile phone was in a sleep type of mode but still receiving power, by shaking, touching the display, pressing a key, etc. Initialization functions are carried out in many types of electronic equipment and will depend on the various functions, capabilities, etc. of the equipment, as is known. For example, the operating circuitry may be set to default condition for normal operation of the mobile phone 1. At block 72 an inquiry is made whether motion has been detected, e.g., by one or more of the motion sensors 3. If no, then a loop is followed back to the input of block 72 until motion has been detected.

If at block 72 motion had been detected, then at block 73 an inquiry is made whether the motion is a specific type of motion that represents a motion input to the mobile phone that would represent a given function, such as, for example, to move in a list, to move to point to another icon in a GUI, etc. For example, linear motion may represent such a specific type of motion whereas a twisting of the mobile phone held in a user's had by rotating the user's wrist back and forth may not be such specific type of motion. These are only examples; and it will be appreciated that there may be other types of specific motion to which the mobile phone is intended to respond and those to which the mobile phone is not ordinarily intended to respond. If the motion is not the specific type of motion, then a loop is followed back to the input to block 72. If the detected motion is the specific type to which the mobile phone is intended to respond, then at block 74 an inquiry is made whether the motion is sufficient. For example, if the motion is only a slight motion inadequate to move from one item in a list to the next item in the list, then the loop would be followed back to the input to block 72; but if the motion is sufficient at block 74, then the logic of the flow chart moves to block 75.

At block 75 the character of the motion is determined, for example, to determine whether the detected motion is up, down, up and down, left, right, left and right, rotational, etc. Determining the character of the motion also may include the number of units of motion, e.g., were there one shake or more than one shake, one rotation or more than one rotation, were the motions back and forth generally linearly or rotationally, distance moved, frequency of the motion, etc.

At block 76 the character of the motion is coordinated with the mobile phone 1 setting or operation 77. For example, if the mobile phone were set to play songs based on operation by the user and if a list of songs 50 (FIG. 5) were shown on the display 14, then the motion is coordinated with the list of songs to move up or down in the list, depending on the character of the motion, e.g., upward or downward, magnitude or extent of the motion or number of shakes, etc., to determine the number of songs to move in the list. Similar operation may be carried out if a GUI were being shown on the display to coordinate the motion with a moving from pointing at one icon to pointing at another icon.

At block 78 the motion as coordinated with the current mobile phone setting or operation will be interpreted. For example, if a list of songs 50 is being shown on the display and if the shake is adequate to move down one song in the list, then at block 78 the controller 30 of the operating circuitry 4 would access the next song in the list from the memory and would cause the display controller 32 (FIG. 3) to highlight or to point to the next song in the list of songs shown on the display 14. Similarly, if the motion were of the appropriate character to move two songs in the list, such interpretation would provide for moving those two songs.

After the character of the motion as coordinated with the mobile phone setting or operation has been interpreted, then at block 79 haptic output feedback is provided to indicate to the user the result of such interpretation. Also, at block 80 the interpreted result may be carried out. For example, if the haptic output represents moving down one song in the list of songs, then at block 80 the carried out result may be a showing on the display 14 that such movement has been achieved. Carrying out the interpreted result at block 80 also or alternatively may be a playing of the newly selected song either automatically without further inputs by the user or by the user simply pressing one of the keys 16 of the mobile phone; in either case it may be unnecessary for the user to look at the display to know what will be happening automatically or what would happen if the user were to press the mentioned key, e.g., playing of the newly selected song. The haptic feedback would provide such information to the user without the need to divert the user's eyes to look at the display 14.

The providing of haptic output feedback at block 79 may be set up in a variety of ways. For example, the haptic output feedback may indicate to the user what would happen, is happening, or had happened as a result of the motion, e.g., how the mobile phone had interpreted the motion. For example, the haptic output feedback may indicate to the user that upon pressing a key the next song (or a second or third, etc., subsequent song) would begin playing, that the next song, etc., is starting to play, that the next song already is playing. Similarly the set up of the mobile phone and operating circuitry 4 thereof may be arranged to indicate what would happen, is happening or had happened as a result of pointing to a new icon in a GUI, etc.

Referring briefly to FIG. 11, an example of a logic diagram or flow chart 85 for playing a game using the mobile phone 1 and the operating circuitry 30 to play a game, e.g., an electronic game or computer game application stored in memory 34 is shown. The haptic feedback or haptic output from respective energized haptic devices 2 may simulate physical movement in a computer game. At block 86 the mobile phone is initialized for playing a game. At block 87 the game is played. At block 88 an inquiry is made whether motion is required. If no, then a loop is followed back to the input to block 88. This may be a constant loop waiting for a prescribed output from the game, for example. If at block 88 it is determined that motion is required, then at block 89 the motion output is provided using one or more of the haptic devices 2, depending on the character of the motion, e.g., is the motion to be linear, repeating pulses, circular or rotating, or rotation or pivoting of the mobile phone 1, etc. Linear motion may be, for example, along the x, y or z axes, along a diagonal, as were described above. Rotational motion may be in the direction of the arrow X′ in FIG. 1. Circular rotation sensation may be by sequentially pulsing the haptic devices 2a, 2b, 2c, 2d (FIG. 9). Tilting motion sensation may be obtained by simultaneously or sequentially pulsing the haptic devices 2e, 2f (FIG. 9). Other motion also may be obtained, depending on the placement, capabilities and operation of the haptic devices 2 of the haptic output device 2′.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable electronic device, comprising
a control responsive to an input to the portable electronic device, and
a haptic output device adapted to provide a haptic output representing interpretation of the input to the portable electronic device by the control.

2. The device of claim 1, said haptic output device comprising a plurality of haptic devices operable by the control in cooperative relation to provide a tactile sense of movement in a direction.

3. The device of claim 2, said haptic devices being cooperable to provide a tactile sense of rotational motion of the portable electronic device.

4. The device of claim 2, said control comprising a motion sensor and a processor.

5. The device of claim 4, said control comprising a memory and program code used by the control to carry out functions of the portable electronic device.

6. The device of claim 2, the haptic output device adapted to respond of the control to provide a haptic output for the portable electronic device representing the interpretation of motion by the control to carry out respective functions of the portable electronic device.

7. The device of claim 1, the control comprising circuitry to provide to the haptic output device a signal that has a relatively steep slope to rapidly cause the haptic output device to provide a tactile output and a subsequent relatively gradual slope to allow the haptic output device to return relatively gradually to a relatively resting mode after the having provided a haptic output.

8. The device of claim 2, said haptic output device providing linear motion output.

9. The device of claim 1, the portable electronic device having a number of functions, wherein the control is responsive to motion of the portable electronic device to navigate to or through such functions, and wherein the haptic output device provides an output representing the extent, if any, of such navigation.

10. The device of claim 2 the portable electronic device comprising a game, and the haptic output device provides haptic output representing at least one of interpretation of movement as input to the game or output information relevant to the game.

11. The device of claim 1, wherein the haptic output device provides a relatively upward motion to the portable electronic device to represent a positive response and a relatively downward motion to the portable electronic device to represent a negative response.

12. The device of claim 1, wherein the portable electronic device is cooperable with another portable electronic device to communicate therewith, and the haptic output device provides a haptic output representing such communication.

13. The device of claim 1, wherein the portable electronic device includes a function that occurs upon tilting, and wherein the haptic output device provides a tilting motion as a representation that the function is being carried out.

14. The device of claim 2, wherein the portable electronic device comprises a mobile phone.

15. The device of claim 14, wherein the control is responsive to an input representing completing of a phone call to another phone or a busy condition of a called phone, and the haptic output device provides a haptic feedback representing such input.

16. The device of claim 4, said motion sensor comprising an number of accelerometers.

17. The device of claim 2, said haptic output device comprising a motor, coin motor, vibrating motor or vibrator adapted to provide force feedback that is linearly directional, rotational or tilting.

18. A method of indicating the result of selecting a function of a mobile device in response to an input to the mobile device or to completing a telephone call or a called telephone busy condition, comprising
providing haptic feedback representative of such input.

19. The method of claim 18, further comprising moving the mobile device to select a function among a grid of functions or an item in a list of items, and wherein the haptic feedback represents interpretation of such moving.

20. The method of either claim 18, said providing haptic feedback comprising providing force feedback to give a sensation of a bump or thump, a linear motion, a tilting motion or a rotation.
